(19) United States
(12) Patent Application Publication
(10) Pub. No.: US 2011/0306389 A1
(43) Pub. Date: Dec. 15, 2011

(54) IMAGE DISPLAY CONTROL SYSTEM FOR MULTIPLE APPARATUSES

(76) Inventor: Koji NAGAYAMA, Iwaki (JP)

(21) Appl. No.: 13/113,500

(22) Filed: May 23, 2011

(30) Foreign Application Priority Data
Jun. 10, 2010 (JP) 2010-132517

(51) Int. Cl. G09G 5/00; G01C 21/26; G08G 1/00

(52) U.S. Cl. 455/557; 345/2.3; 701/117

(57) ABSTRACT

In an image display control system for multiple apparatuses, a portable information portable apparatus is connected to an in-vehicle apparatus by a communication link. The system displays different images in the portable apparatus display and on the in-vehicle apparatus, respectively. A main image is displayed on the in-vehicle apparatus, and an auxiliary image is displayed in the portable apparatus. When rotation of the portable apparatus is detected, the system determines that the user wants to view the image in greater detail on the portable apparatus. Appropriate images are then displayed on the respective image display screens in various modes. When the function of the in-vehicle apparatus is activated, an image transmitted from the in-vehicle apparatus is displayed in the portable apparatus.

### PRIORITY CLAIM

This application claims the benefit of Japanese Patent Application No. 2010-132517, filed on Jun. 10, 2010, and which is incorporated by reference herein in its entirety.

### BACKGROUND

1. Field of the Invention

The present invention relates to an image display control system for multiple apparatuses capable of, when a portable information apparatus, such as a smart phone, having various functions including a telephone function is brought into a vehicle, communicating with a head unit or the like in the vehicle to display various images different from those displayed in an image display unit in the portable information apparatus on a monitor in the vehicle.

2. Description of the Related Art

Mobile phones incorporate more and more functions in recent years. The mobile phones are capable of not only performing telephone and mail communication but also receiving various services over the Internet communication network and are also capable of performing a wide variety of functions by using various kinds of software. In addition, personal digital assistants (PDAs) that have been used also expand their capabilities and are capable of receiving various services over the Internet communication network by using a telephone function. User-friendly and highly functional PDAs are achieved by downloading a variety of software according to a user's preference. Such personal digital assistants are generally called smart phones and various types of smart phones are provided by many companies. The mobile phones are provided with functions that are substantially similar to those of the smart phones because of the higher capabilities of the mobile phones and it is difficult to discriminate the mobile phones from the smart phones.

The highly functional mobile phones and the smart phones are called portable information apparatuses for short in this specification. Such a portable information apparatus is capable of connecting to the Internet by using the telephone function, as described above, to download desired audio, record the downloaded audio in a high-capacity hard disk or memory, and use the recorded audio. Accordingly, such a portable information apparatus is used as an audio device that is daily carried by a user, instead of a portable audio player in related art. The audio function is a main function of the portable information apparatus.

The portable information apparatus with a global positioning system (GPS) receiver and navigation software is capable of using a map database recorded on a data recording medium of the portable information apparatus or downloading necessary map data or the like from a center that provides the map data to set a destination, calculate a guide route, and provide a guidance to the destination after the guide route is determined. Accordingly, such a portable information apparatus functions as a portable navigation apparatus. When this portable information apparatus is brought into a vehicle, the portable information apparatus functions as a car navigation system.

Prevalence of digital terrestrial broadcasting in recent years allows various portable devices to easily receive a digital broadcast, such as a one-segment broadcast. The portable information apparatus with a digital broadcast receiving function is capable of receiving the digital broadcast at anytime and the user can watch the received digital broadcast. Accordingly, some of the recent portable information apparatuses function also as a digital broadcast receiver.

Downloading desired information by connecting to the Internet communication network and accessing various sites or downloading information by registering a Web site according to the user's preference in advance and accessing the Web site if necessary is also a main function of the portable information apparatus.

The portable information apparatus having a communication function, such as Bluetooth, is capable of communicating with a surrounding apparatus having a similar communication function to recognize the surrounding apparatus and establish necessary data communication. Accordingly, when the portable information apparatus is brought into a vehicle, the portable information apparatus is capable of communicating with a head unit or a navigation apparatus provided in the vehicle. An image in the portable information apparatus can be displayed on a monitor in the vehicle or an image in an audio device in the head unit or the navigation apparatus in the vehicle can be displayed in an image display unit in the portable information apparatus.

When a vehicle is provided with a camera capturing images outside the vehicle and an image captured by the camera is displayed on the monitor and a top-view image resulting from conversion of the image captured by the camera into an image having a viewpoint at an upper part of the vehicle is displayed on the monitor, such various images can be transmitted to the portable information apparatus to be displayed in the portable information apparatus. In this case, information detected by a sonar that is provided in the vehicle and that prevents contact with a surrounding object can also be transmitted to the portable information apparatus.

For example, a technology in which, when a personal digital assistant capable of two-way communication with a navigation apparatus is provided near the navigation apparatus in a state in which multiple images are superposed on one another on a monitor in the navigation apparatus, the images to be superposed on one another on the monitor screen are capable of being displayed in a display unit in the personal digital assistant is disclosed in Japanese Unexamined Patent Application Publication No. 2005-284886. A technology in which the position where a menu icon is displayed is automatically reset in accordance with a change of a display frame or switching of the position of a display screen is disclosed in Japanese Unexamined Patent Application Publication No. 10-49334.

A technology in which longitudinal menu display is adopted when a monitor of a device is longitudinally arranged with a cover of the device opened and lateral menu display is adopted when the monitor is rotated around a hinge to be laterally arranged is disclosed in Japanese Unexamined Patent Application Publication No. 2006-80878. A technology in which longitudinal forms and lateral forms can be created only by switching between a longitudinal screen and a lateral screen in creation of the forms is disclosed in Japanese Unexamined Patent Application Publication No. 10-26964.

As described above, the portable information apparatus is capable of performing many functions as the functionality of the portable information apparatus is diversified in recent years. In particular, when the portable information apparatus is brought into a vehicle, the portable information apparatus is capable of two-way data communication with an apparatus in the vehicle by using a communication function, such as Bluetooth, and an image output from the portable information apparatus can be displayed on a monitor in the vehicle.

Similarly, a screen image of the audio device or the navigation apparatus in the vehicle is capable of being transmitted to the portable information apparatus to be displayed in the image display unit in the portable information apparatus. In addition, when a camera capturing images outside the vehicle is mounted in the vehicle, an image captured by the camera is capable of being displayed on the monitor in the vehicle in order to monitor the rear area of the vehicle and further monitor the entire surrounding area of the vehicle. When a system that detects an obstacle and issues a warning exists, an image output from the system is also capable of being transmitted to the portable information apparatus for display.

However, in the related art, even when the above-described portable information apparatus is brought into a vehicle and the portable information apparatus is capable of communication with an apparatus in the vehicle, an image of audio that is being played back, which is displayed in the image display unit in the portable information apparatus brought into the vehicle, is the same as that displayed on a monitor in the vehicle through a head unit communicatively connected to the portable information apparatus, as in an example in FIG. 13.

In this case, when a person in the vehicle, such as a driver, listens to the audio from the portable information apparatus brought into the vehicle with an in-vehicle audio device, it is not necessary for the person who is viewing information about a playback tune displayed on the monitor to view an image displayed in the image display unit in the portable information apparatus, thus making the display in the image display unit in the portable information apparatus meaningless.

Since such a portable information apparatus has higher capability to display images to clearly display television images and has the increasing number of functions, the portable information apparatus brought into the vehicle is frequently placed on, for example, part of a front panel such that the screen is visible, instead of being put into a pocket. In this case, if information enlarged on the monitor is the same as that displayed in the relatively small portable information apparatus, the image in the portable information apparatus is made meaningless.

As a countermeasure, for example, in the display in the portable information apparatus while audio is being played back, an image different from the image that is currently displayed in the portable information apparatus can be displayed from the portable information apparatus in the head unit in the vehicle with unique software. However, the head unit in the vehicle cannot determine which software the audio is currently being played back within the portable information apparatus, one of the pieces of software provided by a lot of software creators is frequently used in the information processing apparatus, and the software is updated in version up. Accordingly, it is substantially not possible to interpret the software and set the software such that a specific image is downloaded into the head unit.

Accordingly, it is necessary for the software in the portable information apparatus to make it possible to differentiate the image output in the portable information apparatus in response to activation of one function of the portable information apparatus from the image output in the in-vehicle monitor in response thereto.

However, for example, when an image captured by the camera capturing images outside the vehicle is to be displayed in both the in-vehicle monitor and the image display unit in the portable information apparatus, the head unit controlling the activation of the camera should support the display. Similarly, also when an image different from the image displayed in the in-vehicle monitor is to be displayed in the image display unit in the portable information apparatus brought into the vehicle while audio is being played back in the head unit, the image display is controlled by the head unit.

The above-described portable information apparatus is sometimes viewed in a lateral mode in which the screen is horizontally long and is sometimes viewed in a longitudinal mode in which the screen is vertically long. Which screen is in the longitudinal mode or in the lateral mode is determined in advance in the software corresponding to the function which the portable information apparatus is currently activating.

In particular, the recent portable information apparatus having a gyro function is capable of detecting the orientation of the apparatus, that is, detecting a motion, such as rotation, of the apparatus. Such a portable information apparatus is capable of detecting whether the portable information apparatus is laterally arranged or longitudinally arranged, and the screen can be switched between the lateral display and the longitudinal display. In the switching between the lateral display and the longitudinal display, the content of the display is also differentiated therebetween.

When the user of the portable information apparatus carries the portable information apparatus that is currently laid down in his/her hand, the user usually carries the portable information apparatus in the longitudinal mode because of the shape of a palm of the user. The user carries the portable information apparatus in his/her hands when the user wants to perform a specific function of the portable information apparatus that is laterally arranged. Accordingly, the switching from the lateral mode to the longitudinal mode of the portable information apparatus can be detected to estimate the intent of the user to perform a certain operation.

Control to differentiate the image displayed in the image display unit in the apparatus itself from the image displayed in the image display unit in an external apparatus is not sufficiently achieved regardless of the above-described various functions of the portable information apparatus. In particular, a technology to appropriately change the image display in the respective apparatuses has not been developed, despite the fact that the portable information apparatus is capable of detecting the motion, such as the rotation, of the apparatus itself to estimate the intent of the user.

### SUMMARY

In order to resolve the above problems, it is an object of the present invention to provide an image display control system for multiple apparatuses capable of avoiding waste to provide an increasing amount of information by differentiating the image displayed in an image display unit in a portable information apparatus main body from the image displayed in an image display unit in an external apparatus in display of images in multiple image display units including the image display unit in the apparatus itself and the image display unit in the external apparatus. In particular, it is an object of the present invention to provide an image display control system for multiple apparatuses capable of utilizing a function in which the portable information apparatus detects a motion, such as rotation, of the apparatus main body to estimate the intent of a user and changes the displayed image in the display of the images in the multiple image display units.

According to an embodiment of the present invention, an image display control system for multiple apparatuses includes a communication unit configured to communicate with an external apparatus; an apparatus motion detecting unit configured to detect a certain motion of an apparatus main body; an external-apparatus image display control unit configured to perform output control of an image to be displayed in an image display unit in the external apparatus; and an apparatus-main-body image display control unit configured to perform output control so as to display an image different from the image output from the external-apparatus image display control unit in an image display unit in the apparatus main body. When a motion of the apparatus main body is detected by the apparatus motion detecting unit, the external-apparatus image display control unit performs the output control so as to display a certain image in the image display unit in the external apparatus and the apparatus-main-body image display control unit performs the output control so as to display an image that is different from the image before the motion of the apparatus main body is detected by the apparatus motion detecting unit and that is different from the certain image displayed by the external-apparatus image display control unit.

In the image display control system for multiple apparatuses, the apparatus motion detecting unit may detect a rotation motion of the apparatus main body.

In the image display control system for multiple apparatuses, before a motion of the apparatus main body is detected by the apparatus motion detecting unit, the external-apparatus image display control unit may display a first image of a function performed by the apparatus main body in the image display unit in the external apparatus and the apparatus-main-body image display control unit may display a second image of the function, different from the first image.

In the image display control system for multiple apparatuses, when a motion of the apparatus main body is detected by the apparatus motion detecting unit, the image displayed by the external-apparatus image display control unit may be the same image as that displayed before the motion is detected.

In the image display control system for multiple apparatuses, when a motion of the apparatus main body is detected by the apparatus motion detecting unit, the image displayed by the apparatus-main-body image display control unit may be an operation screen to perform the function performed by the apparatus main body.

In the image display control system for multiple apparatuses, the first image may be a main image in which main information about the function performed by the apparatus main body is displayed, and the second image may be an auxiliary image for the main image, which is the first image.

In the image display control system for multiple apparatuses, when the apparatus main body performs an audio output function, the external-apparatus image display control unit may display a main image of audio output and the apparatus-main-body image display control unit may display an auxiliary image of the audio output. When a motion of the apparatus main body is detected by the apparatus motion detecting unit, the apparatus-main-body image display control unit may display an audio search image.

In the image display control system for multiple apparatuses, when the apparatus main body performs a navigation function, the external-apparatus image display control unit may display a main image for the navigation and the apparatus-main-body image display control unit may display an auxiliary screen for the navigation. When a motion of the apparatus main body is detected by the apparatus motion detecting unit, the apparatus-main-body image display control unit may display a navigation search image.

In the image display control system for multiple apparatuses, when the apparatus main body performs a navigation function, the external-apparatus image display control unit may display a main image for search for a destination of the navigation and the apparatus-main-body image display control unit may display a map of a recommenced point in the search for a destination of the navigation. When a motion of the apparatus main body is detected by the apparatus motion detecting unit, the external-apparatus image display control unit may display information about the recommended point and the apparatus-main-body image display control unit may display an facility information image at the recommended point.

In the image display control system for multiple apparatuses, when the apparatus main body performs a navigation function, the external-apparatus image display control unit may display traffic information associated with map data on a map and the apparatus-main-body image display control unit may display traffic information that is not associated with map data. When a motion of the apparatus main body is detected by the apparatus motion detecting unit, the apparatus-main-body image display control unit may display the traffic information in a text form.

In the image display control system for multiple apparatuses, when the apparatus main body performs a digital television receiving function, the external-apparatus image display control unit may display a reception image of a digital television broadcast and the apparatus-main-body image display control unit may display a data broadcast image of the digital television broadcast. When a motion of the apparatus main body is detected by the apparatus motion detecting unit, the apparatus-main-body image display control unit may display an image resulting from a communication start operation to a communication start display unit displayed on the data broadcast.

In the image display control system for multiple apparatuses, the external-apparatus image display control unit may stop output of an image to be displayed in the image display unit in the external apparatus at least before a motion of the apparatus main body is detected by the apparatus motion detecting unit to allow the external apparatus to display a unique image.

In the image display control system for multiple apparatuses, when a motion of the apparatus main body is detected by the apparatus motion detecting unit, the apparatus-main-body image display control unit may display a communication destination list corresponding to the function that is being performed by the apparatus main body and the external-apparatus image display control unit may display a map of a communication destination point selected from the communication destination list.

In the image display control system for multiple apparatuses, when the apparatus main body performs an information delivery service receiving function, the apparatus-main-body image display control unit may display an information delivery service guide. When a motion of the apparatus main body is detected by the apparatus motion detecting unit, the apparatus-main-body image display control unit may display detailed information about an information source selected from the displayed information delivery service guide and the external-apparatus image display control unit may display other detailed information about the selected information source.

In the image display control system for multiple apparatuses, when the apparatus main body performs a navigation function and an information delivery service receiving function, the apparatus-main-body image display control unit may display an information delivery service guide. When the navigation function causes a state in which an intersection guide is output and a motion of the apparatus main body is detected by the apparatus motion detecting unit, the external-apparatus image display control unit may display the intersection guide and the apparatus-main-body image display control unit may display detailed information about an information source selected from the displayed information delivery service guide.

The image display control system for multiple apparatuses may further include a communication unit configured to control disconnection of the communication between the apparatus main body and the external apparatus. When the apparatus main body performs a telephone function, the apparatus-main-body image display control unit may display a telephone operation function image. When a motion of the apparatus main body is detected by the apparatus motion detecting unit, the external-apparatus image display control unit may display a communication disconnection clear screen in the image display unit in the external apparatus, the communication unit may disconnect the communication with the external apparatus, and the apparatus-main-body image display control unit may display a telephone call function image.

In the image display control system for multiple apparatuses, the image displayed in the apparatus main body may be an image that is output when the function of the external apparatus is activated and that is received from the external apparatus, and the apparatus-main-body image display control unit may display different images before and after a motion of the apparatus main body is detected by the apparatus motion detecting unit.

In the image display control system for multiple apparatuses, the function of the external apparatus may be a navigation function and the apparatus-main-body image display control unit may display different navigation images before and after a motion of the apparatus main body is detected by the apparatus motion detecting unit.

In the image display control system for multiple apparatuses, the function of the external apparatus may be an audio function and the apparatus-main-body image display control unit may display different images concerning audio playback before and after a motion of the apparatus main body is detected by the apparatus motion detecting unit.

In the image display control system for multiple apparatuses, the function of the external apparatus may be a vehicle surrounding monitoring function. When the external apparatus performs a function to monitor the surrounding of a vehicle with a camera and a sonar, an image monitored by the camera may be displayed in the image display unit in the external apparatus and the apparatus-main-body image display control unit may display an image indicating the result of the monitoring by the sonar received from the external apparatus. When a motion of the apparatus main body is detected by the apparatus motion detecting unit, the apparatus-main-body image display control unit may display an enlarged image, captured by the camera, around an obstacle that is detected.

According to the present invention, the image display control system for multiple apparatuses is capable of avoiding waste to provide an increasing amount of information by differentiating the image displayed in the image display unit in the apparatus main body from the image displayed in the image display unit in the external apparatus in display of images in multiple image display units including the image display unit in the apparatus main body and the image display unit in the external apparatus. In particular, when the information processing apparatus detects a motion, such as rotation, of the apparatus main body, it is possible to estimate the intent of a user on the basis of the motion and to effectively perform display control so as to display images associated with each other in the multiple image display units.

### BRIEF DESCRIPTION OF THE DRAWINGS

FIG. 1 is an exemplary functional block diagram according to an embodiment of the present invention;

FIG. 2 is a table showing examples in which embodiments of the present invention are realized;

FIG. 3 is a flowchart showing an example of a common operational process in the present invention;

FIGS. 4A to 4E show a first exemplary embodiment of the present invention;

FIGS. 5A to 5E show a second exemplary embodiment of the present invention;

FIGS. 6A to 6E show a third exemplary embodiment of the present invention;

FIGS. 7A to 7E show a fourth exemplary embodiment of the present invention;

FIGS. 8A to 8E show a fifth exemplary embodiment of the present invention;

FIGS. 9A to 9E show a sixth exemplary embodiment of the present invention;

FIGS. 10A to 10E show a seventh exemplary embodiment of the present invention;

FIGS. 11A to 11E show an eighth exemplary embodiment of the present invention;

FIGS. 12A to 12E show a ninth exemplary embodiment of the present invention; and

FIG. 13 shows an example in related art.

### DETAILED DESCRIPTION

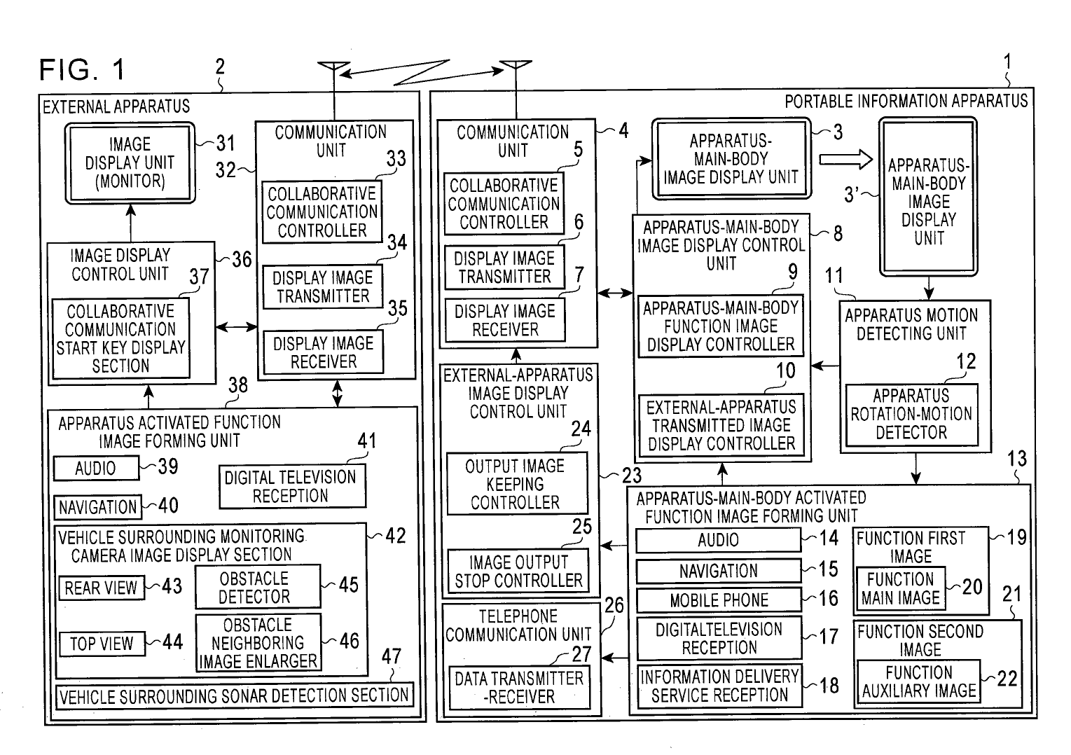

Exemplary embodiments of the present invention will herein be described with reference to the attached drawings. FIG. 1 is an exemplary functional block diagram according to an embodiment of the present invention. Various functional units are provided in the example in FIG. 1 so as to realize the present invention by the various embodiments. Accordingly, arbitrary functional units can be selected from the functional units to realize the present invention by the various embodiments.

In the exemplary functional block diagram in FIG. 1, when a portable information apparatus 1, such as a smart phone, a highly functional mobile phone, or a PDA with a telephone function, is brought into a vehicle, the portable information apparatus 1 is connected to an external apparatus 2, such as a head unit or a navigation apparatus, mounted in the vehicle with a communication unit 4 in the portable information apparatus 1 and a communication unit 32 in the external apparatus 2 by using communication means, such as Bluetooth, allowing data communication between portable information apparatus 1 and the external apparatus 2.

The communication unit 4 in the portable information apparatus 1 is provided with the communication means performing the same function as that of the communication means provided in the communication unit 32 in the external apparatus 2. The communication unit 4 in the portable information apparatus 1 includes a collaborative communication controller 5 capable of collaborative communication with various external apparatuses provided with the same communication means. In the example in FIG. 1, the collaborative communication controller 5 is activated collaboratively with a collaborative communication controller 33 in the communication unit 32 in the external apparatus 2 by using the same communication software.

A display image transmitter 6 in the communication unit 4 transmits an image to be displayed in the external apparatus, output from the portable information apparatus 1. This is a main function in the embodiment of the present invention, performed by the communication unit 4. A display image receiver 7 in the communication unit 4 receives an image to be displayed in an apparatus-main-body image display unit 3 in the portable information apparatus 1 from a display image transmitter 34, supplies the received image to an apparatus-main-body image display control unit 8, and displays the received image in the apparatus-main-body image display unit 3 when the external apparatus 2 is provided with an outside monitoring unit, such as an outside monitoring camera or a sonar, and performs the function of the outside monitoring unit. The communication unit 32 in the external apparatus 2 receives the image transmitted from the display image transmitter 6 in the communication unit 4 in the portable information apparatus 1, supplies the received image to an image display control unit 36, and displays the image in an image display unit 31, such as a monitor.

The apparatus-main-body image display control unit 8 in the portable information apparatus 1 acquires an image that is formed by an apparatus-main-body activated function image forming unit 13 described below in response to activation of each function of the apparatus main body, and displays a certain image in the apparatus-main-body image display unit 3 with an apparatus-main-body function image display controller 9. Although this component 3 is referred to as the apparatus main body, portable apparatus main body, or portable apparatus, as used herein, such an apparatus need not necessarily be portable, and may be fixed or removable relative to the vehicle.

An external-apparatus transmitted image display controller 10 in the apparatus-main-body image display control unit 8 supplies an image to be displayed in the apparatus-main-body image display unit 3 in the portable information apparatus 1, which is transmitted with the function of the external apparatus 2 and is received by the display image receiver 7, to the apparatus-main-body image display unit 3. For example, when the external apparatus 2 is a head unit mounted in a vehicle and the head unit is used to perform the image display control of a camera capturing images around the vehicle, the external-apparatus transmitted image display controller 10 displays part of the image to be displayed received with the communication unit 4 in the portable information apparatus 1. When monitoring information around the vehicle acquired with the sonar is transmitted from the vehicle, the external-apparatus transmitted image display controller 10 also displays the monitoring information.

For example, when the portable information apparatus 1 does not have a navigation function or uses the function of an in-vehicle navigation apparatus serving as the external apparatus 2 without using the navigation function and the image to be displayed is transmitted from the external apparatus 2, the external-apparatus transmitted image display controller 10 controls the image so as to be displayed in the apparatus-main-body image display unit 3. Similarly, also when the external apparatus 2 performs an unique audio function and the image to be displayed in the apparatus-main-body image display unit 3 in the portable information apparatus 1 is transmitted from the external apparatus 2, the external-apparatus transmitted image display controller 10 controls the image so as to be displayed in the apparatus-main-body image display unit 3.

An apparatus motion detecting unit 11 in the portable information apparatus 1 detects a motion, such as rotation, of the apparatus main body with an apparatus rotation-motion detector 12 by using a gyro function or the like provided in the apparatus main body when the apparatus-main-body image display unit 3 is changed from a lateral mode in which the apparatus-main-body image display unit 3 is laterally arranged to a longitudinal mode in which the apparatus-main-body image display unit 3 is longitudinally arranged, which is indicated by an apparatus-main-body image display unit 3′ in FIG. 1, in response to a user's operation in which the user carries the portable information apparatus 1 in his/her hand to perform a certain operation. The apparatus-main-body image display unit 3′ is also referred to as the integral display screen solely to identify that the display is part of the portable apparatus, and does not describe the manner in which the display is formed, embedded, or attached to the portable apparatus. The change of the apparatus-main-body image display unit 3 from the longitudinal mode to the lateral mode is also detected in the same manner. The apparatus-main-body image display control unit 8 selects an image to be displayed on the basis of the detected signal by using the function of software of the apparatus main body and performs the image display control.

An apparatus-main-body activated function image forming unit 13 in the portable information apparatus 1 forms an image used by the user to input an instruction signal in each of the functions, an image used to display information to the user for presentation, etc. when the various functions of the portable information apparatus 1 are performed. The apparatus-main-body activated function image forming unit 13 also forms an image to be displayed in the image display unit 31 in the external apparatus 2, in addition to the image to be displayed in the apparatus-main-body image display unit 3. The image to be displayed in the image display unit 31 in the external apparatus 2 is not an image that is exclusively used for the display in the image display unit 31 but an image that can also be displayed in the apparatus-main-body image display unit 3 in response to an operation for the portable information apparatus 1.

Only functions exemplified in the embodiments of the present invention described below, among the various function performed by the portable information apparatus 1, are shown in the apparatus-main-body activated function image forming unit 13 in FIG. 1. Accordingly, many kinds of images can be further formed in the apparatus-main-body activated function image forming unit 13.

In the apparatus-main-body activated function image forming unit 13, an audio function 14 is activated when, for example, each of many tunes accumulated in the portable information apparatus 1 or a tune downloaded by using a mobile phone function is played back. In particular, since the output from a speaker mounted in the portable information apparatus 1 is restricted in quality and volume, the user frequently listens to each tune with a high-quality high-capacity audio apparatus provided in a vehicle when the portable information apparatus 1 is brought into the vehicle. Accordingly, it is important that the audio data is supplied to the external apparatus 2, such as a head unit, for playback and that various images are displayed in a relatively large monitor in the external apparatus 2. It is especially important to allow an image that serves as auxiliary data for the image being displayed on the monitor in the external apparatus and that is different from the image displayed in the external apparatus to be displayed in the apparatus-main-body image display unit 3.

A navigation function 15 allows the portable information apparatus 1 to operate as a navigation apparatus when the portable information apparatus 1 is provided with a GPS receiver and navigation software, and map data and facility data are recorded on a data recording medium in the main body of the portable information apparatus 1 or a map image, etc. can be downloaded from an external information center and the downloaded map image is available. Since the navigation apparatus is highly sophisticated, the navigation apparatus forms many images in order to provide various instruction input screens and a variety of information to the user. Accordingly, it is important in the embodiments of the present invention that which image is displayed in the image display unit in the main body of the portable information apparatus 1 and the image display unit in the external apparatus 2, such as an in-vehicle monitor.

With the navigation function 15, the portable information apparatus 1 is capable of giving a guidance including traffic jam information when the portable information apparatus 1 is provided with a Vehicle Information and Communication System (VICS) receiving function and the portable information apparatus 1 is capable of accessing the information center to download similar traffic information even when the portable information apparatus 1 is not provided with the VICS receiver. Accordingly, appropriate traffic information can be displayed in each image display unit.

A mobile phone function 16 is used to make a call with a telephone communication unit 26 in the portable information apparatus 1 and is a main function of the portable information apparatus 1. It is necessary to appropriately perform selection of a partner of the telephone call, display during the telephone call, display of a received image with a television telephone function, display of an image that is being transmitted, etc. in the mobile phone function 16.

A digital television reception function 17 is used to display a main screen of a television broadcast that is received and display a variety of data transmitted in the digital television broadcast. For example, when an access point of a specific company, a personal Web page, or an information providing department is displayed on the screen as part of the data, any of them can be selected and instructed to automatically download the information from the selected one and to display the information.

An information delivery service reception function 18 is used to display a list of access points from which an access point is selected and instructed, display a screen used for the selection and instruction, and display various images corresponding to the received information when a Web site, etc. is accessed through the Internet communication network to receive desired information.

The image forming function of the apparatus-main-body activated function image forming unit 13 in the portable information apparatus 1 in FIG. 1 is used to form a function first image 19 and a function second image 21 different from the function first image 19 in the display of images in the apparatus-main-body image display unit 3 and the image display unit 31 in the external apparatus 2, from a viewpoint different from that of the activated function image formation performed by the apparatus main body. When the function first image 19 is a function main image 20, among multiple images that are displayed, a function auxiliary image 22, which is an auxiliary image for the function main image 20, is displayed as the function second image 21. In particular, when the function main image 20 is displayed in the relatively large monitor in the external apparatus, the function auxiliary image 22 is displayed in the apparatus-main-body image display unit having a relatively small screen.

An external-apparatus image display control unit 23 in the portable information apparatus 1 controls an image different from the image displayed in the apparatus-main-body image display unit 3, among the images formed by the apparatus-main-body activated function image forming unit 13, so as to be displayed in the image display unit 31 in the external apparatus 2. In addition to the display control of the images formed in the apparatus-main-body activated function image forming unit 13, an output image keeping controller 24 in the external-apparatus image display control unit 23 keeps the display mode of the output image, regardless of the change in the function activated in the external apparatus 2 or the change, such as a motion, of the portable information apparatus 1. Accordingly, when the portable information apparatus 1 is used to make a call while the navigation apparatus is being activated, the external apparatus 2 is capable of keeping the activation, such as the display of the map image in the navigation apparatus, regardless of the telephone function that is newly activated in the portable information apparatus 1.

An image output stop controller 25 in the external-apparatus image display control unit 23 controls the image displayed in the image display unit 31 in the external apparatus 2 so as not to be displayed to stop the output of the image, while the external-apparatus image display control unit 23 is used to perform the image display control described above to the image displayed in the image display unit 31 in the external apparatus 2. No image to be displayed is supplied from the portable information apparatus 1 to the external apparatus 2 and an image specific to the external apparatus 2, such as a navigation image in response to activation of a function of the external apparatus itself, can be displayed in the external apparatus 2.

The telephone communication unit 26 is provided with the mobile phone function, which is a main function of the portable information apparatus 1. The telephone communication unit 26 is used to perform the normal transmission and reception with the mobile phone and a mail function as in the related art. A data transmitter-receiver 27 in the telephone communication unit 26 performs reception of a variety of information in the portable information apparatus 1 and transmission of data from the user, if needed.

The external apparatus 2 in FIG. 1 includes the communication unit 32, as in the portable information apparatus 1. The collaborative communication controller 33 in the communication unit 32 collaboratively communicates with the portable information apparatus 1 by using, for example, the Bluetooth. The display image transmitter 34 in the communication unit 32 transmits an image to be displayed in the image display unit 31 in the external apparatus 2 in a certain function when the external apparatus 2 performs the function. A display image receiver 35 in the communication unit 32 receives the image the display control of which is performed by the external-apparatus image display control unit 23 in the portable information apparatus 1, supplies the received image to the image display control unit 36, and displays the image in the image display unit 31.

The image display control unit 36 in the external apparatus 2 displays an image of each function performed by the external apparatus 2, in addition to the display of the image received from the portable information apparatus 1. A collaborative communication start key display section 37 in the image display control unit 36 displays a key indicating that the collaborative communication is started in response to an operation of the displayed key in the image display unit 31 in the external apparatus 2 in order to easily start the collaborative communication from the external apparatus 2 later and to indicate that the collaborative communication between the apparatuses is not currently being performed in the case that a motion of the portable information apparatus 1 is detected and the collaborative communication controller 5 in the communication unit 4 disconnects the collaborative communication with the communication unit 32 in the external apparatus 2, for example, when the user picks up the portable information apparatus 1 to make a telephone call while the portable information apparatus 1 is collaboratively communicates with the external apparatus 2. This display operation is supplied from the external-apparatus image display control unit 23 in the portable information apparatus 1 to the external apparatus 2 before the control of the disconnection of the collaborative communication.

When the external apparatus 2 is, for example, an in-vehicle head unit and is provided with an audio function 39 that uniquely operates, an apparatus activated function image forming unit 38 in the external apparatus 2, for example, plays back audio recorded on a radio receiver or a data recording medium or plays back a tune in a memory or a portable audio device additionally connected to the head unit. Also during the playback of the audio or the tune, the image displayed in the image display unit 31 in the external apparatus 2 is appropriately differentiated from the image displayed in the portable information apparatus 1 according to the purpose of the present invention in the image display similar to that with the audio function 14 in the apparatus-main-body activated function image forming unit 13 in the portable information apparatus 1.

When the external apparatus 2 is a vehicle navigation apparatus, a navigation function 40 in the apparatus activated function image forming unit 38 is used to perform the image display similar to that with the navigation function 15 in the portable information apparatus 1. Traffic jam information from Level 1 to Level 3 can be acquired from the data received by the VICS receiver and the information can be appropriately displayed in the image display unit in each apparatus.

When the head unit or the like is provided with a television receiver for digital broadcasting, a digital television reception function 41 in the apparatus activated function image forming unit 38 is used to perform the image display similar to that with the digital television reception function 17 in the portable information apparatus 1. Specifically, a television main image is displayed in the image display unit 31 in the external apparatus 2, and a data broadcast that is received and a Web site that is accessed and displayed in association with the data broadcast are displayed in the apparatus-main-body image display unit 3 in the portable information apparatus 1.

A vehicle surrounding monitoring camera image display section 42 in the apparatus activated function image forming unit 38 acquires images captured by a rear camera, a front camera, and left-side and right-side cameras that capture images outside the vehicle, and the image captured by the rear camera is displayed in the image display unit 31 serving as a monitor to perform a rear view function 43 in order to monitor the rear area when the vehicle is moving backward. A top view function 44 is used to monitor the surrounding area of the vehicle. With the top view function 44, the images captured by the respective cameras are combined to display the combined image as if it were an image captured by one camera arranged at an upper part of the vehicle. An obstacle detector 45 in the vehicle surrounding monitoring camera image display section 42 detects an obstacle.

An obstacle neighboring image enlarger 46 in the vehicle surrounding monitoring camera image display section 42 is used to detect an obstacle by various methods in the related art on the basis of the above images captured by the cameras. When a vehicle surrounding sonar detection section 47 detects an obstacle to which the vehicle is approaching with a sonar, the image captured by the camera capturing the position where the obstacle exists is enlarged to indicate the presence of the obstacle to the driver or the like.

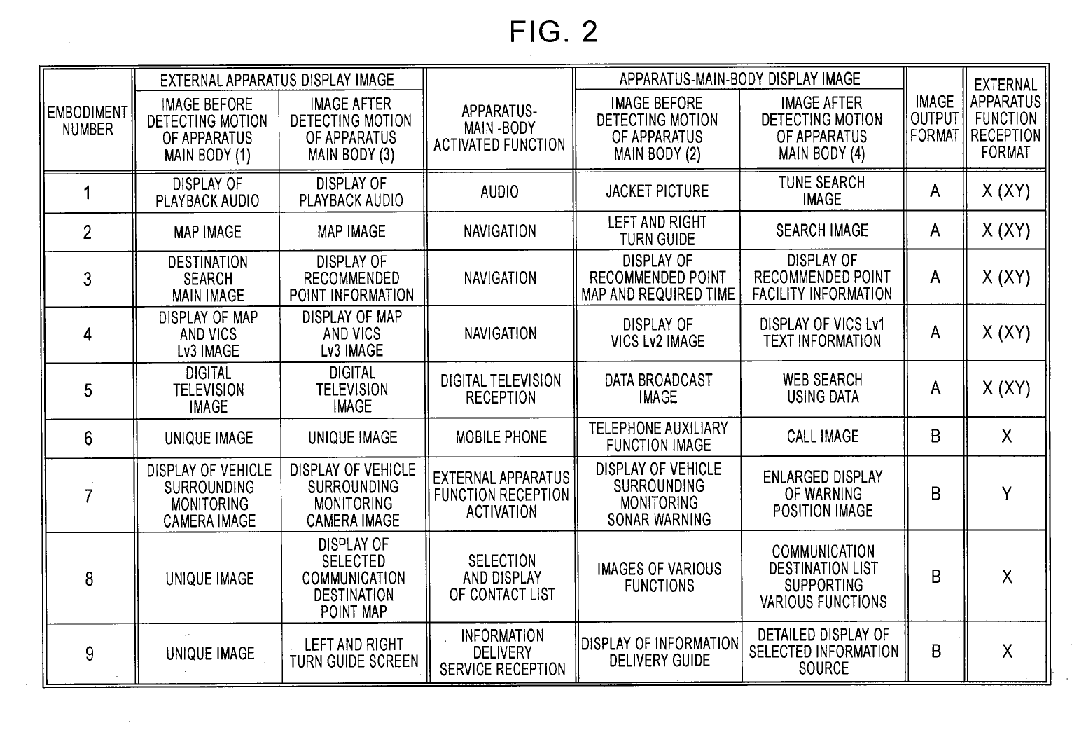

The various functional units shown in FIG. 1 are provided to realize the embodiments of the present invention. FIG. 2 is a table showing examples of images displayed in the external apparatus and images displayed in the apparatus main body. External apparatus display images and apparatus-main-body display images are displayed in association with apparatus-main-body activated functions in various embodiments indicated by embodiment numbers 1 to 9. FIG. 2 shows examples of the external apparatus display images and the apparatus-main-body display images before and after a motion of the apparatus main body is detected. The images in the embodiments are output in an image output format A in which the image output from the apparatus main body to the external apparatus is performed or in an image output format B in which the image output from the apparatus main body to the external apparatus is stopped.

The functions of the external apparatus are received in an external apparatus function reception format X in which the image display in accordance with the function of the external apparatus is not performed, an external apparatus function reception format Y in which the image display in accordance with the function of the external apparatus is performed, or an external apparatus function reception format XY in which the image display in accordance with the function of the external apparatus is not performed or is performed. Although the external apparatus function reception format X is indicated as the format X from the viewpoint of the use of the portable information apparatus, the external apparatus function reception format X can be realized as the external apparatus function reception format XY in many of the embodiments.

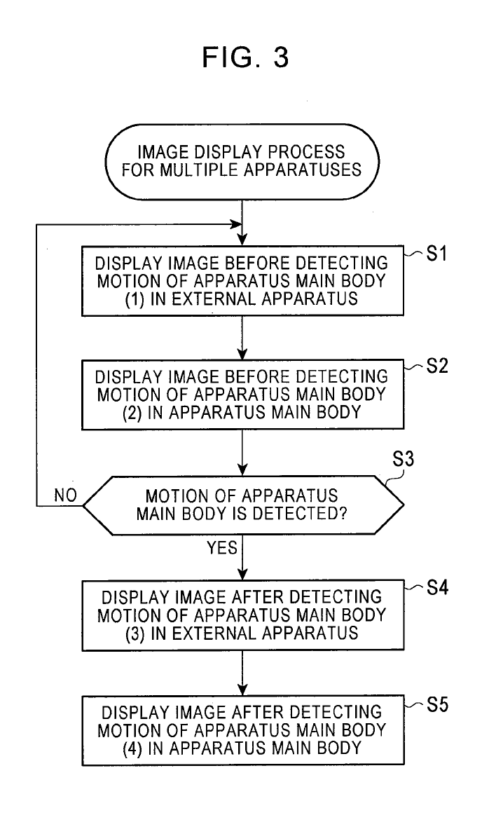

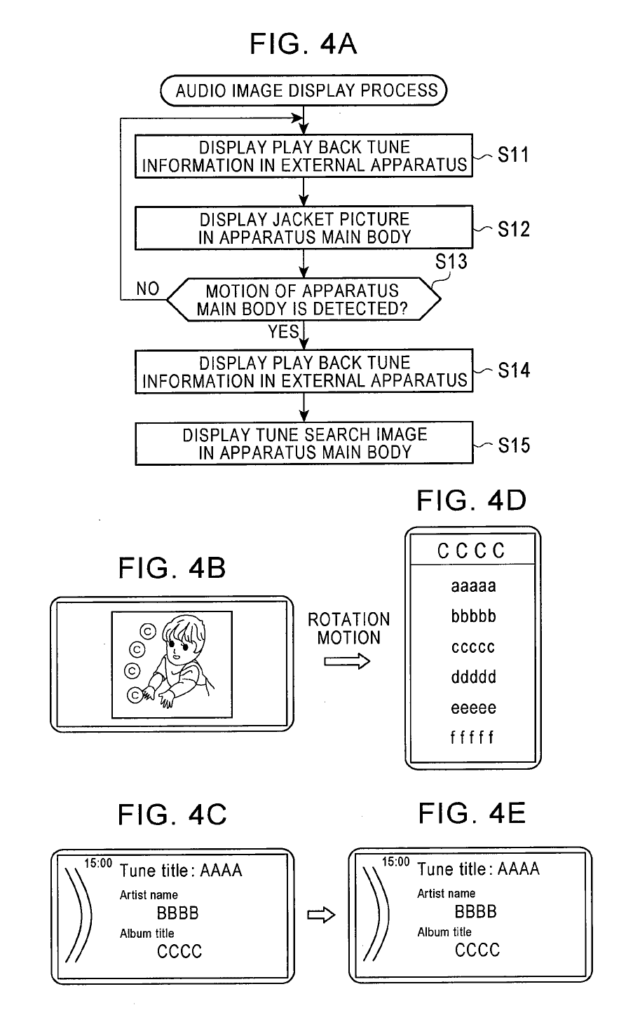

FIG. 3 is a flowchart showing an example of a common operational process for the embodiment numbers 1 to 9 in FIG. 2. FIGS. 4 to 12 include flowcharts showing examples of operational processes in the embodiment numbers 1 to 9, respectively, and examples of display in each image display unit. The operational process in FIG. 3 is a basic operational flow in the embodiments of the present invention. In an image display process for multiple apparatuses in FIG. 3, image display in the external apparatus in Step S1 and image display in the apparatus main body in Step S2 are performed before determination of whether a motion of the apparatus main body is detected in Step S3.

Referring to FIG. 3, in Step S1, an image before detecting a motion of the apparatus main body (1), among the external apparatus display images in the table in FIG. 2, is displayed in the external apparatus. In Step S2, an image before detecting a motion of the apparatus main body (2), among the apparatus-main-body display images in the table in FIG. 2, is displayed in the apparatus main body. Step S2 may be performed before Step S1 or Steps S1 and S2 may be simultaneously performed. The same applies to the embodiments in FIGS. 4 to 12.

In Step S3, it is determined whether a motion of the apparatus main body is detected. Specifically, the apparatus motion detecting unit 11 in FIG. 1 detects a change in the orientation of the portable information apparatus from the lateral mode to the longitudinal mode, for example, when the user picks up the portable information apparatus with a gyroscope provided in the apparatus. If it is determined that a motion of the apparatus main body is not detected (NO in Step S3), the process goes back to Step S1 to continue the display of the image in each apparatus.

If it is determined that a motion of the apparatus main body is detected (YES in Step S3), the image processing after a motion of the apparatus main body is detected is performed. Specifically, in Step S4, an image after detecting a motion of the apparatus main body (3), among the external apparatus display images in the table in FIG. 2, is displayed in the external apparatus. In Step S5, an image after detecting a motion of the apparatus main body (4), among the apparatus-main-body display images in the table in FIG. 2, is displayed in the apparatus main body. Step S5 may be performed before Step S4 or Steps S4 and S5 may be simultaneously performed. The same applies to the embodiments in FIGS. 4 to 12 except some of them.

The common operational process in FIG. 3 is the basic operation in the embodiments of the present invention. A combination of the common operational process with the examples of the display images in FIG. 2 results in the operational processes in FIGS. 4 to 12 in which the image display is performed. Exemplary embodiments will now be described with reference to FIGS. 4 to 12.

### First Exemplary Embodiment

FIGS. 4A to 4E show a first exemplary embodiment of the present invention. FIG. 4A corresponds to the embodiment number 1 in FIG. 2. An example of an audio image display process is shown in FIGS. 4A to 4E. Referring to FIG. 4A, after the portable information apparatus is brought into a vehicle and the portable information apparatus is connected to a head unit or the like in the vehicle by using, for example, the Bluetooth so as to be capable of data communication, in Step S11, information about a tune that is being played back is displayed in the image display unit in the external apparatus.

Specifically, when many tunes according to the user's preference are recorded on the high-capacity data recording medium in the portable information apparatus brought into the vehicle and the user who constantly carries the portable information apparatus gets in the driver seat or the front seat in the vehicle, the user frequently wants to listen to a tune in the portable information apparatus which the user carries with a high-performance in-vehicle audio device.

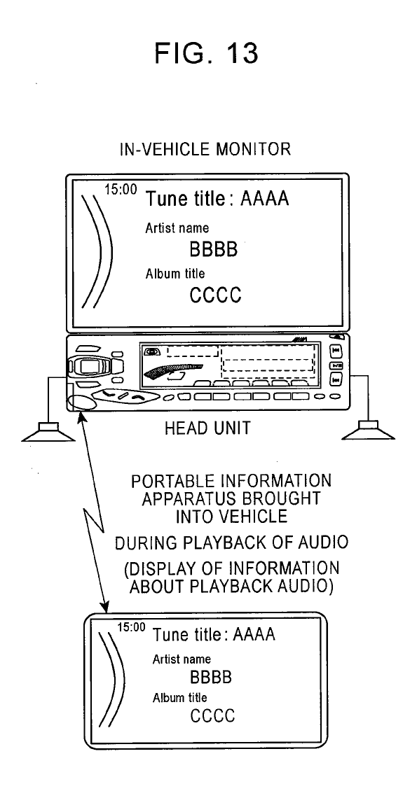

In such a case, the portable information apparatus is connected to the head unit in the vehicle by using, for example, the Bluetooth so as to be capable of data communication. When an audio playback screen is displayed in response to a user's operation on the portable information apparatus, the external-apparatus image display control unit 23 in the portable information apparatus 1 displays an image that is usually displayed in the apparatus-main-body image display unit 3 in the manner in FIG. 13 in the image display unit 31 in the external apparatus 2, that is, on the monitor functioning as the image display unit for the head unit. Since the image is displayed in the relatively large screen, user-friendly display is realized.

In Step S12, a jacket picture is displayed in the apparatus main body. Specifically, the apparatus-main-body image display control unit 8 in FIG. 1 displays a jacket picture of a tune that is currently being played back, for example, as shown in FIG. 4B. The image of the jacket picture is different from the image displayed by the external-apparatus image display control unit 23 and serves as the auxiliary image when the image displayed by the external-apparatus image display control unit 23 is the main image. The display in the image display unit in the apparatus main body is made meaningless in the related art because the image displayed in the apparatus main body is the same as that displayed in the external apparatus as in the example in FIG. 13. However, the above processing allows the images in the image display units in multiple apparatuses to be associated with each other to realize effective image display.

In Step S13, it is determined whether a motion of the apparatus main body is detected. For example, if a motion in which the apparatus main body is rotated to be changed from the lateral mode to the longitudinal mode is detected (YES in Step S13), in Step S14, information about a tune that is being played back is displayed in the image display unit in the external apparatus. For example, an image in FIG. 4E, which is the same as that in FIG. 4C before the motion of the apparatus main body is detected, is displayed in the external apparatus.

In Step S15, a tune search image is displayed in the image display unit in the apparatus main body. Specifically, when the portable information apparatus placed in the lateral mode is changed to the longitudinal mode in response to, for example, a user's operation in which the user carries the portable information apparatus in his/her hand, it is estimated that the operation is performed to change the current tune to another tune and a list of tunes included in an album including the tune that is currently being played back is displayed in the apparatus main body, as shown in FIG. 4D.

However, instead of the continuation of the display of the image in FIG. 4E, information about a certain tune which is included in the list of tunes in the album displayed in the apparatus main body and to which a cursor is moved may be displayed in the image display unit in the external apparatus or the information about the certain tune and the current image may be displayed in a split manner in the image display unit in the external apparatus.

Different images are displayed in the image display units in multiple apparatuses when the user listens to a tune played back in the portable information apparatus with the head unit in the vehicle in the above example. The similar image display may be performed with the software of the head unit serving as the external apparatus in FIG. 1 when the audio function of the head unit mounted in the vehicle is activated. However, also in this case, a unique image display process may be performed, for example, different images that are associated with each other may be displayed in response to a rotation motion of the portable information apparatus.

### Second Exemplary Embodiment

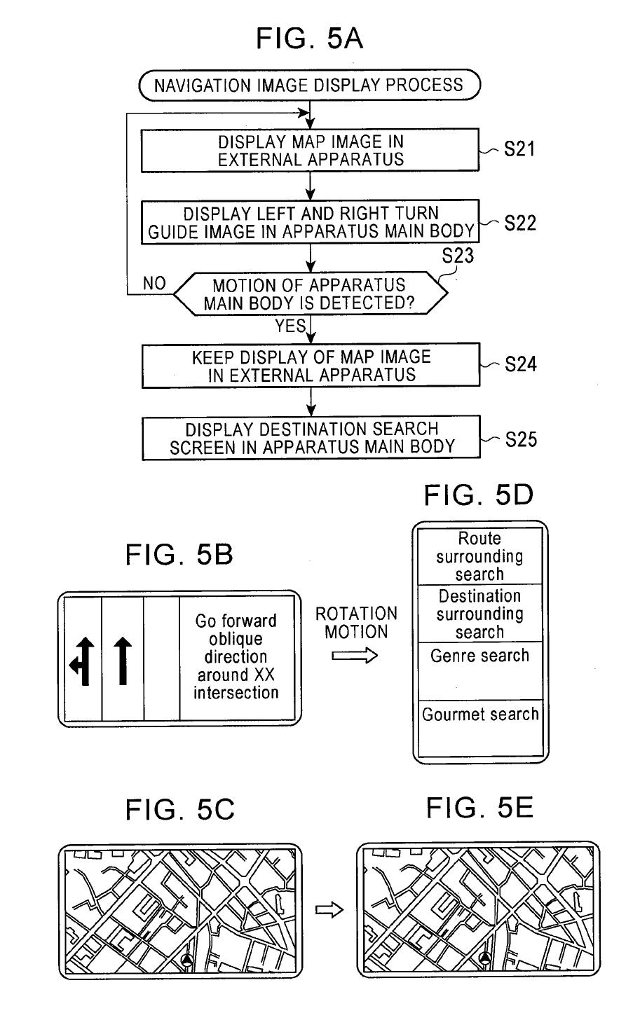

FIGS. 5A to 5E show a second exemplary embodiment of the present invention in which the portable information apparatus 1 is provided with the navigation function. In the example in FIGS. 5A to 5E, the navigation function causes a main map image to be displayed on the monitor serving as the image display unit connected to the head unit in the vehicle when the portable information apparatus 1 is brought into the vehicle and a guide image is displayed in the portable information apparatus 1 when the vehicle is close to an intersection. Referring to FIG. 5A, in Step S21, a map image is displayed in the external apparatus as a first step of a navigation image display process. In Step S22, a left and right turn guide image is displayed in the image display unit in the apparatus main body. The examples in Steps S21 and S22 are shown in FIG. 5C and FIG. 5B, respectively.

In Step S23, it is determined whether a motion of the apparatus main body is detected. If it is determined that a motion of the apparatus main body is detected (YES in Step S23), in Step S24, the display of the map image is kept in the image display unit in the external apparatus, as shown in FIG. 5E. In Step S25, a destination search screen is displayed in the image display unit in the apparatus main body, as shown in FIG. 5D. When the search function displayed in the image display unit in the apparatus main body is activated, a list of specific restaurants is displayed by a Gourmet search, the cursor is positioned on an arbitrary restaurant in the list, the image display unit in the external apparatus may be split into two parts in which a map around the current position and a map of the restaurant on which the cursor is positioned may be displayed.

Also in this embodiment of the present invention, when the navigation apparatus is mounted in the vehicle, the navigation apparatus may be used to perform the navigation function, display a main image on the monitor, and display an auxiliary image in the portable information apparatus. In particular, since the navigation apparatus mounted in the vehicle is capable of accurately detecting the current position with a speed pulse function or a gyro function and has an improved rerouting function, it is efficient to use the navigation apparatus in the vehicle. However, also in this case, when a motion of the portable information apparatus is detected, it is estimated that the user wants to search for a surrounding facility and a neighboring facility search screen is displayed in the image display unit in the portable information apparatus.

### Third Exemplary Embodiment

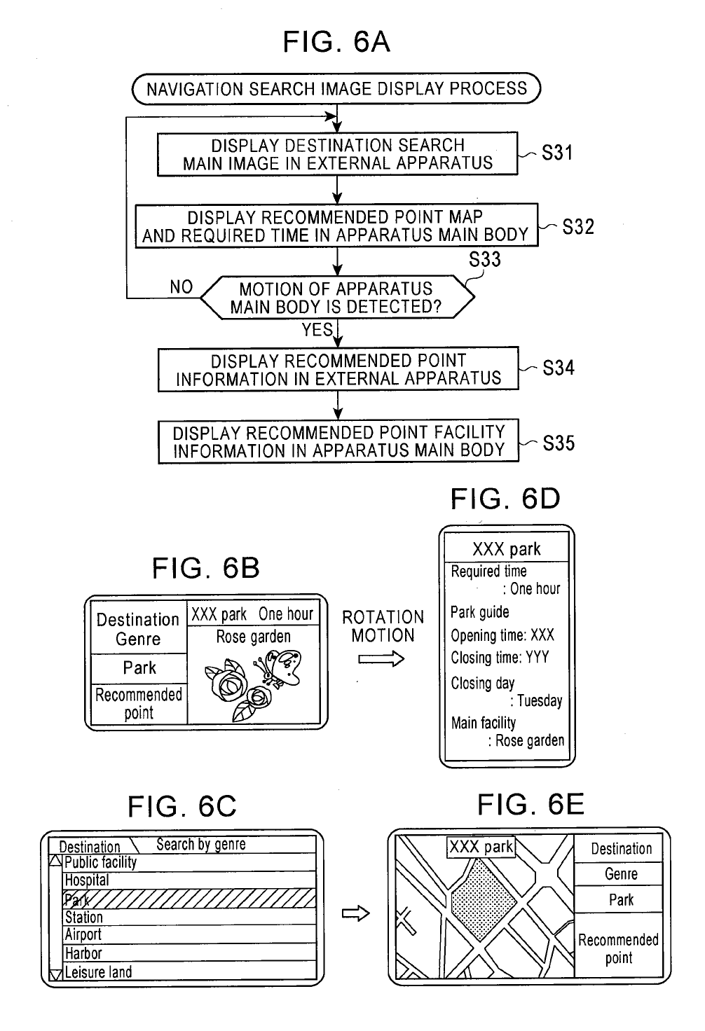

FIGS. 6A to 6E show an example of a navigation search image display process according to a third exemplary embodiment of the present invention. Referring to FIG. 6A, in Step S31, a destination search main image is displayed in the image display unit in the external apparatus, as shown in FIG. 6C. In this example, after the display of the destination search main image, in Step S32, a map of a recommended point and the required time to reach the point are displayed in the image display unit in the apparatus main body, as shown in FIG. 6B. In Step S33, it is determined whether a motion of the apparatus main body is detected. If it is determined that a motion of the apparatus main body is detected (YES in Step S33), in Step S34, a map including information about the recommended point is displayed in the image display unit in the external apparatus, as shown in FIG. 6E. In Step S35, information about a facility at the recommended point is displayed in the image display unit in the apparatus main body, as shown in FIG. 6D.

Also in this example, when the navigation apparatus mounted in the vehicle exists, the third exemplary embodiment of the present invention may be realized by using the high-performance navigation apparatus to perform the image display process similar to the one described above.

### Fourth Exemplary Embodiment

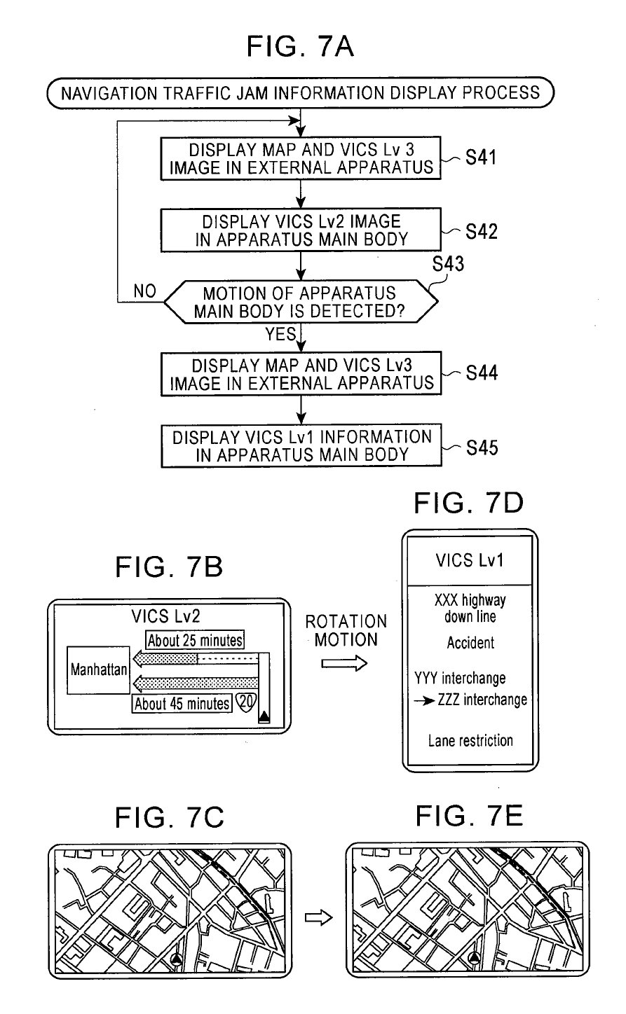

FIGS. 7A to 7E show an example of a traffic jam information display process when the navigation apparatus is used according to a fourth exemplary embodiment of the present invention. Although the traffic jam information in the navigation apparatus is widely used in general vehicle navigation apparatuses as a VICS system, the traffic jam information display process can be performed as a function of the apparatus main body if the portable information apparatus can receive various VICS signals or if VICS information can be acquired from an information center by using the telephone function of the portable information apparatus.

In the example of the traffic jam information display when the navigation apparatus is used in FIGS. 7A to 7E, a map and an image in VICS Level 3 are first displayed in the image display unit in the external apparatus. VICS includes Levels 1 to 3. The traffic jam information is output in a text form in VICS Level 1, the traffic jam information is represented by a map, such as a road network, in VICS Level 2, and the traffic jam information is displayed in association with the map data in VICS Level 3.

Referring to FIG. 7A, in Step S41, a map image shown in FIG. 7C and traffic jam information acquired in VICS Level 3 are displayed on the map in the image display unit in the external apparatus. In Step S42, a traffic jam display image in VICS Level 2 is displayed in the image display unit in the apparatus main body, as shown in FIG. 7B. As a result, the detailed traffic jam information is displayed in the image display unit in the external apparatus as the main screen on which the traffic jam information is displayed, and the eye-friendly traffic jam information in VICS Level 2 is displayed in the image display unit in the portable information apparatus as the auxiliary screen. However, the information in VICS Level 2 is rough, compared with the information in VICS Level 3.

In Step S43, it is determined whether a motion of the apparatus main body is detected. If it is determined that a motion of the apparatus main body is detected (YES in Step S43), in Step S44, an image in VICS Level 3 in which the traffic jam information is displayed on the map is displayed in the image display unit in the external apparatus, as shown in FIG. 7E. In Step S45, text information in VICS Level 1, which is other traffic jam information, is displayed in the image display unit in the apparatus main body, as shown in FIG. 7D.

Also in this example, when the navigation apparatus is mounted in the vehicle, the function of the navigation apparatus may be executed to perform the display process similar to the one described above with software incorporated in advance. In particular, the VICS information is supplied on frequency modulation (FM) multiplex broadcasting, optical beacons, or radio wave beacons and it is necessary to receive the radio waves or the likes to acquire all the information in VICS Level 1 to Level 3 as in the above example. Installation of the functions in the portable information apparatus causes the portable information apparatus to be excessively increased in size. Accordingly, when the navigation apparatus is provided in the vehicle and the VICS information is received, the function of the navigation apparatus is executed and the above image display is performed during the execution.

### Fifth Exemplary Embodiment

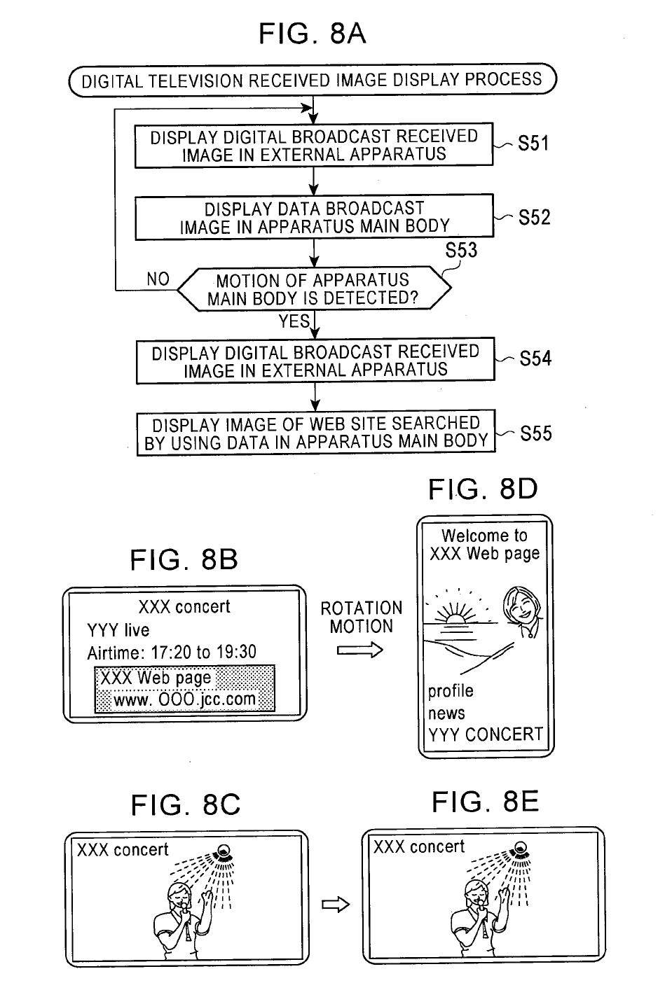

FIGS. 8A to 8E show an example of a digital television received image display process according to a fifth exemplary embodiment of the present invention. In the example in FIGS. 8A to 8E, when the portable information apparatus is provided with a television receiver for digital terrestrial broadcasting, etc. and receives a digital terrestrial broadcast, the received image is displayed in the relatively large monitor in the vehicle during the stop of the vehicle. Referring to FIG. 8A, in Step S51, a digital broadcast image that is received is displayed in the image display unit in the external apparatus, as shown in FIG. 8C. In Step S52, an image of a data broadcast broadcasted in association with the digital broadcast that is being received is displayed in the image display unit in the apparatus main body, as shown in FIG. 8B. In order to provide more detailed information, various access points are displayed in the data broadcast image. The cursor is positioned on an access point and the access point is determined to allow access to the access point.

In Step S53, it is determined whether a motion of the apparatus main body is detected. If it is determined that a motion of the apparatus main body is detected (YES in Step S53), in Step S54, the display of the above main image is kept in the image display unit in the external apparatus, as shown in FIG. 8E. In Step S55, an image of a Web site searched by using the data is displayed in the image display unit in the apparatus main body. Specifically, when the cursor is positioned on the access point to access to the access point, a Web site of an artist who is doing a concert is accessed to display a variety of information about the artist, as shown in FIG. 8D. Also in this example, when a digital broadcast receiver is provided in the vehicle, the digital broadcast receiver may be used to display the main image on the monitor and display the auxiliary image in the image display unit in the portable information apparatus.

### Sixth Exemplary Embodiment

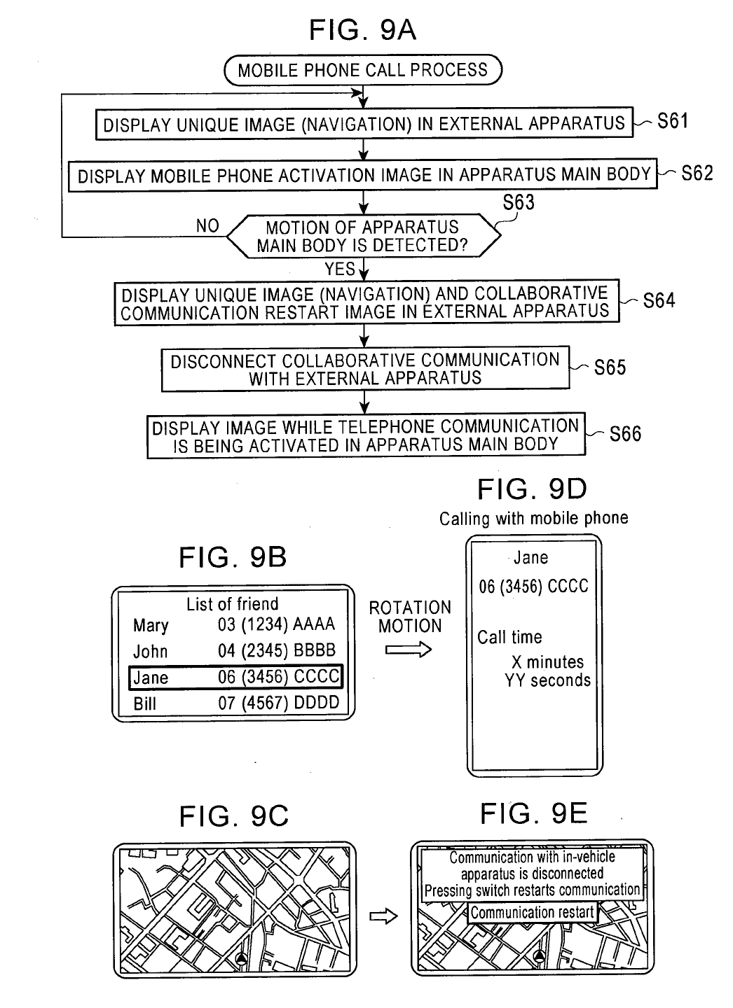

FIGS. 9A to 9E show an example of a mobile phone call process in which a mobile phone is used to make a call, according to a sixth exemplary embodiment of the present invention. Referring to FIG. 9A, in Step S61, an arbitrary unique image is displayed in the image display unit in the external apparatus. For example, a navigation map image shown in FIG. 9C may be displayed in the image display unit in the external apparatus. In Step S62, an auxiliary image for activation of the mobile phone, such as a “List of friends” shown in FIG. 9B, is displayed in the image display unit in the apparatus main body.

In Step S63, it is determined whether a motion of the apparatus main body is detected. If it is determined that a motion of the apparatus main body is detected (YES in Step S63), it is determined that the user carries the mobile phone in his/her hand for a telephone call. Although the telephone call using the portable information apparatus is usually made through the head unit with a hands-free function, the user carries the portable information apparatus serving as the telephone in his/her hand to make a call when the user does not want to listen to the voice through a speaker in the vehicle. Accordingly, the motion of the portable information apparatus is detected to detect the user's operation in which the user carries the portable information apparatus in his/her hand and the collaborative communication between the portable information apparatus and the external apparatus is disconnected in Step S65 in FIG. 9A.

Before the disconnection step, in Step S64, an operation part to restart the collaborative communication after the disconnection, such as a “Communication restart” button shown in FIG. 9E, is displayed on part of the navigation map image that is being displayed in the image display unit in the external apparatus. When the call by using the mobile phone is finished and the collaborative communication between the portable information apparatus and the external apparatus is to be restarted, the user can touch the “Communication restart” button to restart the collaborative communication.

In Step S65, the collaborative communication with the external apparatus is disconnected. In Step S66, an image while the telephone communication is being activated is displayed in the image display unit in the apparatus main body, as shown in FIG. 9D. When the telephone communication is finished, the collaborative communication is restarted in response to a user's operation, for example, in which the user touches the “Communication restart” button displayed in the image display unit in the external apparatus.

### Seventh Exemplary Embodiment

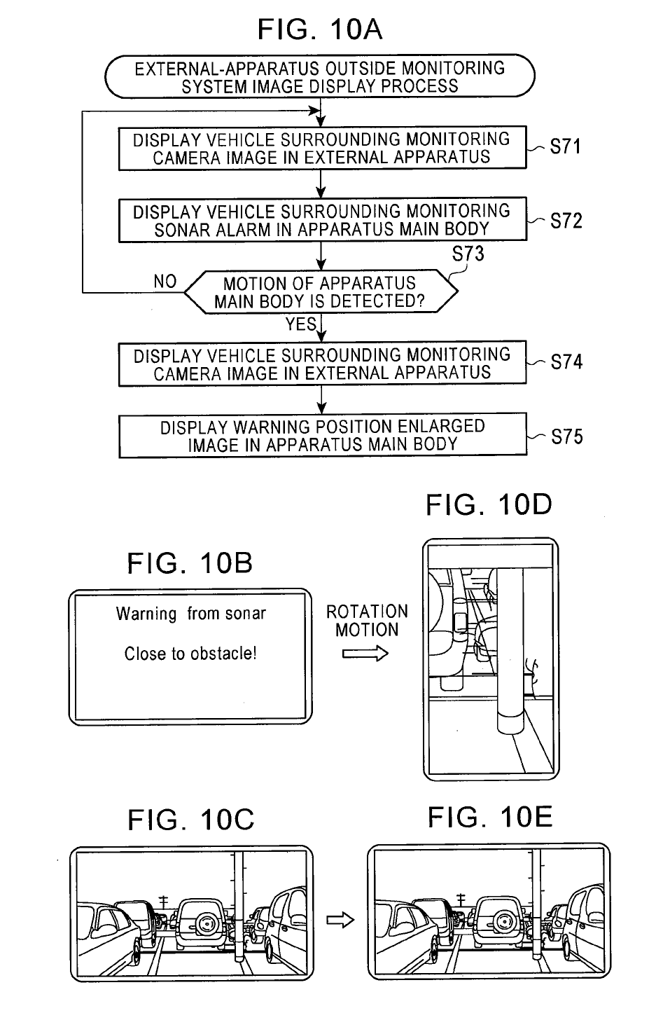

FIGS. 10A to 10E show an example of a process according to a seventh exemplary embodiment of the present invention when the external apparatus is a head unit mounted in the vehicle and the head unit is provided with an outside monitoring system to display an image captured by a camera capturing images outside the vehicle on the monitor. Although there are cases in which only a rear camera is used as the camera capturing images outside the vehicle, there are systems that are provided with cameras capturing images at the front and rear sides and at the left and right sides of the vehicle or any ones among them and that combine the images captured by the cameras to generate a top-view image having the viewpoint at an upper part of the vehicle and display the top-view image in recent years. Furthermore, there are monitoring systems in the related art that receive a reflected wave radiated outside the vehicle from a sonar to detect an object to which the vehicle is approaching.

In the example in FIGS. 10A to 10E, the external apparatus is provided with such a monitoring system and the function of the monitoring system is being performed. Referring to FIG. 10A, in Step S71, an image captured by a vehicle surrounding monitoring camera is displayed in the image display unit in the external apparatus. FIG. 10C shows an example in which an image captured by the rear camera is displayed. In Step S72, a warning from a vehicle surrounding monitoring sonar is displayed in the image display unit in the apparatus main body, as shown in FIG. 10B. A warning indicating that the vehicle is approaching an obstacle is displayed as the result of the monitoring with the sonar in the example in FIG. 10B. In this case, an alarm may be additionally output.

In Step S73, it is determined whether a motion of the apparatus main body is detected. If it is determined that a motion of the apparatus main body is detected (YES in Step S73), in Step S74, the image captured by the vehicle surrounding monitoring camera is continuously displayed in the image display unit in the external apparatus, as shown in FIG. 10E. In Step S75, an image resulting from enlargement of the image captured by the camera of the position where the object to which the vehicle is approaching is detected by the sonar is displayed in the image display unit in the apparatus main body, as shown in FIG. 10D. An image captured by the camera of a portion where the vehicle is obstructed by a utility pole that is put up in a parking space to which the vehicle is going backward and where the vehicle is possibly in contact with the utility pole is enlarged in the example in FIG. 10D.

Since the images captured by the camera are processed by an apparatus, such as the head unit, mounted in the vehicle in this example and the portable information apparatus brought into the vehicle often cannot support the system, the external apparatus function reception format Y in which the image display in accordance with the function of the external apparatus is performed is adopted at least in this example, as shown in the embodiment number 7 in FIG. 2.

The embodiments of the present invention include embodiments, such as the embodiment number 7, in which, when the function of the external apparatus is performed independently of the function of the portable information apparatus, the software of the external apparatus includes a function to display images in multiple image display units of other apparatuses. Accordingly, since the external-apparatus image display control unit 23 in FIG. 1 does not output images from the portable information apparatus 1 to the external apparatus 2 in such a case, the image output from the portable information apparatus to the external apparatus is stopped by the activation of the image output stop controller 25. In the above example, the apparatus activated function image forming unit 38 in the external apparatus 2 in FIG. 1 controls the output of images to the image display units in multiple apparatuses.

### Eighth Exemplary Embodiment

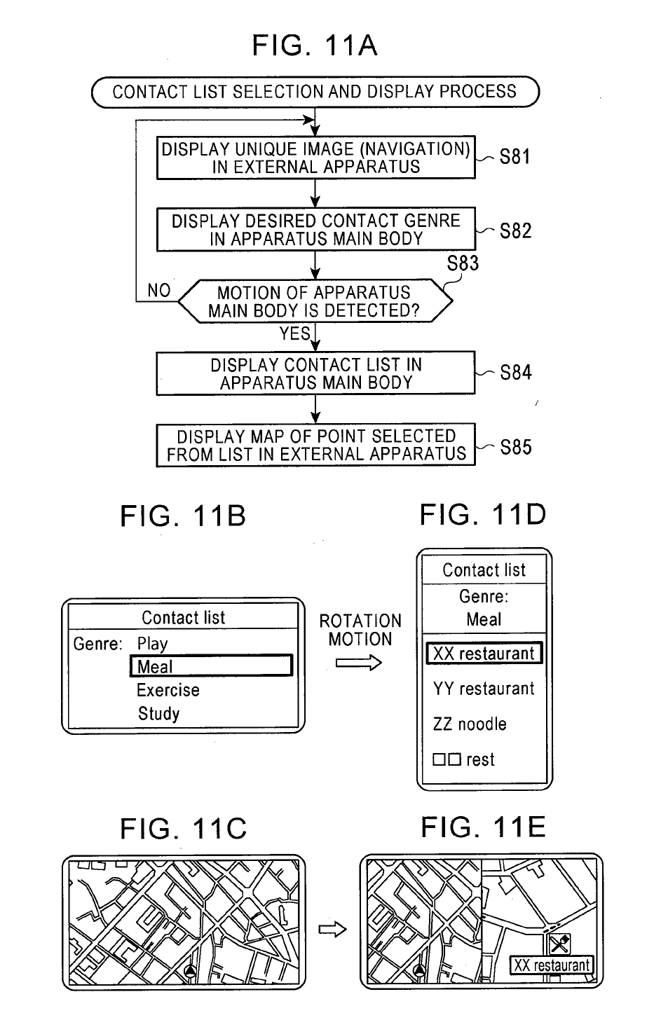

FIGS. 11A to 11E show an example of a contact list selection and display process in which an arbitrary contact list is selected from various contact lists displayed by the portable information apparatus, according to an eighth exemplary embodiment of the present invention. Referring to FIG. 11A, in Step S81, an arbitrary unique image is displayed in the image display unit in the external apparatus. In the example in FIGS. 11A to 11E, a navigation map image is displayed, as shown in FIG. 11C.

In Step S82, functional contact genres are displayed in the image display unit in the apparatus main body. The contact lists support a variety of modes. In the example in FIGS. 11A to 11E, the contact lists are grouped into genres in accordance with the behavior patterns of the user including “Play”, “Meal”, “Exercise”, “Study”, and so on. FIG. 11B shows a state in which the “Meal” is selected from the genres.

In Step S83, it is determined whether a motion of the apparatus main body is detected. If it is determined that a motion of the apparatus main body is detected (YES in Step S83), in Step S84, a contact list is displayed in the image display unit in the apparatus main body, as shown in FIG. 11D. In the example in FIG. 11D, when “Meal” is selected as the genre, various restaurants that have been selected and registered in advance by the user or that have been set and registered by a software creator are displayed and a “XX restaurant” is selected from the contact list.

In Step S85, a map of a point selected from the contact list is displayed in the image display unit in the external apparatus, as shown in FIG. 11E. In the example in FIG. 11E, the screen of the external apparatus is separated into two parts. The display of the map image is continued in the left-side part and a map of the “XX restaurant” is displayed in the right-side part.

### Ninth Exemplary Embodiment

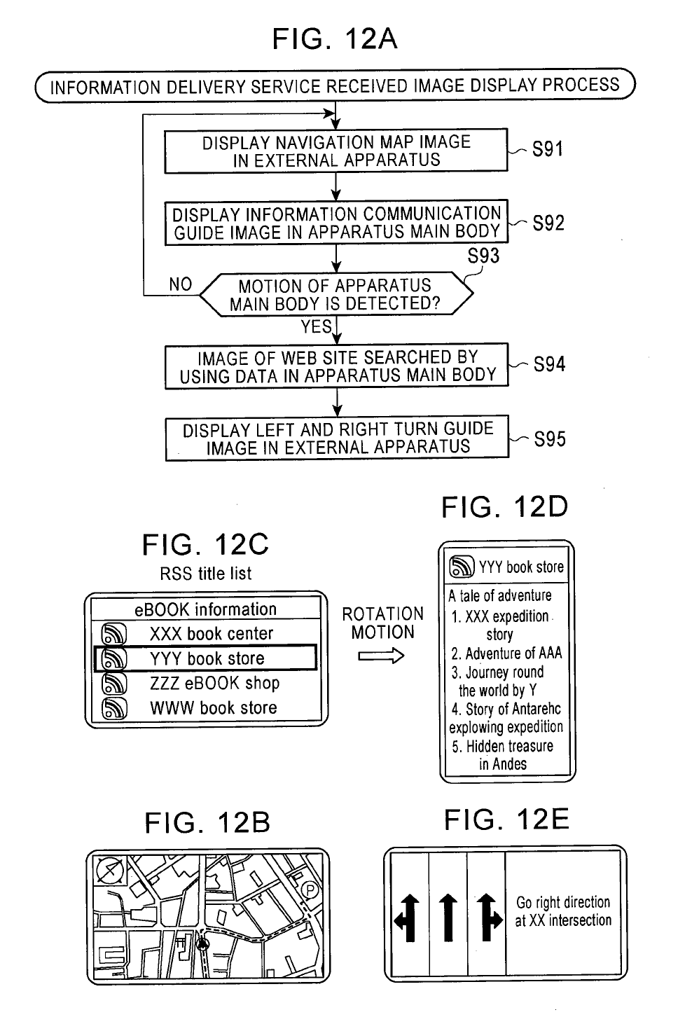

FIGS. 12A to 12E show an example of an image display process when an information delivery service is received, according to a ninth exemplary embodiment of the present invention. Referring to FIG. 12A, in Step S91, a navigation map image is displayed in the image display unit in the external apparatus, as shown in FIG. 12B. In Step S92, an information communication guide image is displayed in the image display unit in the apparatus main body, as shown in FIG. 12C. A typical example of the information communication guide is an information delivery system called “Rich Site Summary (RSS)”, in which a variety of information is guided in a push mode. In the example in FIG. 12C, an RSS list of “eBOOK” information is displayed and the cursor is positioned on a “YYY book store.”

In Step S93, it is determined whether a motion of the portable information apparatus is detected. If it is determined that a motion of the portable information apparatus is detected (YES in Step S93), in Step S94, it is estimated that the user wants to carry the portable information apparatus in his/her hand to watch more detailed information and an image of a Web site searched by using the data is displayed in the image display unit in the apparatus main body. Specifically, as shown in FIG. 12D, the “YYY book store” on which the cursor is positioned is accessed to display books involved in an “A tale of adventure” recommended by the book store.

In Step S95, approach to an intersection is detected with the navigation apparatus and a left and right turn guide image is displayed in the image display unit in the external apparatus, as shown in FIG. 12E. However, when it is not necessary to display the left and right turn guide, the screen may be appropriately divided to display more detailed information about the “YYY book store” selected in FIG. 12C.

As described above, the present invention is realized in a wide variety of embodiments. The most basic technical idea is as follows: different images are displayed in the image display units in multiple apparatuses to avoid waste and, when a motion such as rotation of the portable information apparatus is detected, it is determined that the user is interested in the content that is being displayed in the portable information apparatus to display more detailed information. Although preferred embodiments have been described in detail, the present invention is not limited to these specific embodiments of the present invention. Rather, various modifications and changes can be made without departing from the scope of the present invention as described in the accompanying claims. Accordingly, all such modifications are intended to be included within the scope of this invention as defined in the following claims.

What is claimed is:

1. An image display control system for controlling multiple apparatuses, comprising:
an in-vehicle apparatus having an in-vehicle display unit, and having a communication unit configured to facilitate communication between the in-vehicle apparatus and a portable apparatus, the portable apparatus having an integral display screen;
an apparatus motion detecting unit in the portable apparatus configured to detect certain motion of a portable apparatus;
an external-apparatus image display control unit in the portable apparatus configured control an image displayed on the in-vehicle display unit; and
a portable apparatus image display control unit configured to display an image on the integral display screen, which is different from an image output by the external-apparatus image display control unit to the in-vehicle display unit,
wherein, when motion of the portable apparatus is detected, the external-apparatus image display control unit performs output control so as to display a certain image on the in-vehicle display unit, and the portable apparatus image display control unit displays an image on the integral display screen that is different from the image displayed prior to detection of the motion.

2. The image display control system for multiple apparatuses according to claim 1,
wherein the apparatus motion detecting unit detects a rotation motion of the portable apparatus.

3. The image display control system for multiple apparatuses according to claim 1,
wherein, before a motion of the portable apparatus is detected, the external-apparatus image display control unit displays a first image on the in-vehicle display unit corresponding to a function performed by the portable apparatus, and the portable apparatus image display control unit displays on the integral display screen, a second image of the function, which is different from the first image.

4. The image display control system for multiple apparatuses according to claim 3,
wherein, when a motion of the portable apparatus is detected, the image displayed by the external-apparatus image display control unit is the same image displayed before the motion is detected.

5. The image display control system for multiple apparatuses according to claim 3,
wherein, when a motion of the portable apparatus is detected, the image displayed on the integral display screen corresponds to an operation screen to perform the function performed by the portable apparatus.

6. The image display control system for multiple apparatuses according to claim 3,
wherein the first image is a main image in which main information about the function performed by the portable apparatus is displayed, and
wherein the second image is an auxiliary image for the main image, which is the first image.

7. The image display control system for multiple apparatuses according to claim 6,
wherein, when the portable apparatus performs an audio output function, the external-apparatus image display control unit displays a main image of audio output, and the portable apparatus image display control unit displays an auxiliary image of the audio output, and
wherein, when a motion of the portable apparatus is detected, the portable apparatus image display control unit displays an audio search image.

8. The image display control system for multiple apparatuses according to claim 6,
wherein, when the portable apparatus performs a navigation function, the external-apparatus image display control unit displays a main image for the navigation, and the portable apparatus image display control unit displays an auxiliary screen for the navigation, and
wherein, when a motion of the portable apparatus is detected, the portable apparatus image display control unit displays a navigation search image.

9. The image display control system for multiple apparatuses according to claim 6,
wherein, when the portable apparatus performs a navigation function, the external-apparatus image display control unit displays a main image for a search for a destination, and the portable apparatus image display control unit displays a map of a recommenced point in the search for a destination, and
wherein, when a motion of the portable apparatus is detected, the external-apparatus image display control unit displays information about the recommended point, and the portable apparatus image display control unit displays a facility information image at the recommended point.

10. The image display control system for multiple apparatuses according to claim 6,
wherein, when the portable apparatus performs a navigation function, the external-apparatus image display control unit displays traffic information associated with map data, and the portable apparatus image display control unit displays traffic information that is not associated with map data, and
wherein, when a motion of the portable apparatus is detected, the portable apparatus image display control unit displays the traffic information in text form.

11. The image display control system for multiple apparatuses according to claim 6,
wherein, when the portable apparatus performs a digital television receiving function, the external-apparatus image display control unit displays a reception image of a digital television broadcast, and the portable apparatus image display control unit displays a data broadcast image of the digital television broadcast, and
wherein, when a motion of the portable apparatus is detected, the portable apparatus image display control unit displays an image resulting from a communication start operation.

12. The image display control system for multiple apparatuses according to claim 1,
wherein the external-apparatus image display control unit stops output of an image to be displayed in the in-vehicle image display unit at least before motion of the portable apparatus is detected to allow the in-vehicle apparatus to display a unique image.

13. The image display control system for multiple apparatuses according to claim 12,
wherein, when a motion of the portable apparatus is detected, the portable apparatus image display control unit displays a communication destination list corresponding to the function that is being performed by the portable apparatus, and the external-apparatus image display control unit displays a map of a communication destination point selected from the communication destination list.

14. The image display control system for multiple apparatuses according to claim 12,
wherein, when the portable apparatus performs an information delivery service receiving function, the portable apparatus image display control unit displays an information delivery service guide, and
wherein, when a motion of the portable apparatus is detected, the portable apparatus image display control unit displays detailed information about an information source selected from the information delivery service guide, and the external-apparatus image display control unit displays other detailed information about the selected information source.

15. The image display control system for multiple apparatuses according to claim 12,
wherein, when the portable apparatus performs a navigation function and an information delivery service receiving function, the portable apparatus image display control unit displays an information delivery service guide, and
wherein, when the navigation function causes an intersection guide to be output and a motion of the portable apparatus is detected, the external-apparatus image display control unit displays the intersection guide, and the portable apparatus image display control unit displays detailed information about an information source selected from the displayed information delivery service guide.

16. The image display control system for multiple apparatuses according to claim 12, wherein:
the communication unit is configured to terminate communication between the portable apparatus and the in-vehicle apparatus,
wherein, when the portable apparatus performs a telephone function, the portable apparatus image display control unit displays a telephone operation function image, and
wherein, when motion of the portable apparatus is detected, the external-apparatus image display control unit displays a communication disconnection clear screen on the in-vehicle display unit, the communication unit terminates communication with the in-vehicle apparatus, and the portable apparatus image display control unit displays a telephone call function image.

17. The image display control system for multiple apparatuses according to claim 12,
wherein the image displayed on the integral display screen corresponds to an image when the function of the in-vehicle apparatus is activated, and
wherein the portable apparatus image display control unit displays different images before and after a motion of the portable apparatus is detected.

18. The image display control system for multiple apparatuses according to claim 17,
wherein, when the function of the in-vehicle apparatus is a navigation function, the portable apparatus image display control unit displays different navigation images before and after motion of the portable apparatus is detected.

19. The image display control system for multiple apparatuses according to claim 17,
wherein, when the function of the in-vehicle apparatus is an audio function, the portable apparatus image display control unit displays different images concerning audio playback before and after motion of the portable apparatus is detected.

20. The image display control system for multiple apparatuses according to claim 17,
wherein the function of the in-vehicle apparatus is a vehicle surrounding monitoring function,
wherein, when the in-vehicle apparatus performs a function to monitor the surrounding of a vehicle with a camera and a sonar, an image monitored by the camera is displayed on the in-vehicle display unit, and the portable apparatus image display control unit displays an image indicating a result of the monitoring function, and
wherein, when a motion of the portable apparatus is detected, the portable apparatus image display control unit displays an enlarged image captured by the camera, around an obstacle that is detected.
